(19) United States
(12) Patent Application Publication
(10) Pub. No.: US 2014/0066320 A1
(43) Pub. Date: Mar. 6, 2014

(54) IDENTIFYING CAUSAL GENETIC MARKERS FOR A SPECIFIED PHENOTYPE

(71) Applicants: David Earl Heckerman, Santa Monica, CA (US); Jennifer Listgarten, Santa Monica, CA (US); Christoph Anthony Lippert, Los Angeles, CA (US); Jing Xiang, Pittsburgh, PA (US); Nicolo Fusi, Los Angeles, CA (US); Carl M. Kadie, Bellevue, WA (US); Robert I. Davidson, Kirkland, WA (US)

(72) Inventors: David Earl Heckerman, Santa Monica, CA (US); Jennifer Listgarten, Santa Monica, CA (US); Christoph Anthony Lippert, Los Angeles, CA (US); Jing Xiang, Pittsburgh, PA (US); Nicolo Fusi, Los Angeles, CA (US); Carl M. Kadie, Bellevue, WA (US); Robert I. Davidson, Kirkland, WA (US)

(73) Assignee: MICROSOFT CORPORATION, Redmond, WA (US)

(21) Appl. No.: 13/603,403

(22) Filed: Sep. 4, 2012

(51) Int. Cl. C40B 30/02

(52) U.S. Cl. 506/8

(57) ABSTRACT

Described herein are technologies pertaining to computationally-efficiently performing genome-wide association studies. Feature selection methods are used to identify genetic markers for addressing potential confounding in the data. Then, single SNPs, or groups of genetic markers are analyzed to ascertain whether such groups are causal or tagging of causal as to a specified phenotype, after taking in to account the feature-selected SNPs. Group and univariate analysis is accomplished by way of analyzing a group of genetic markers conditioned upon other genetic markers that are found to be predictive of the specified phenotype.

### BACKGROUND

In the recent past, Genome Wide Association Studies (GWASs) have been undertaken in an attempt to identify association between genetics and disease. A GWAS is an examination of many common genetic markers across different individuals to ascertain if a particular marker is associated with a certain phenotype. A phenotype is a trait, such as height of an individual, weight of an individual, diseases that afflict an individual, etc. Typically, single nucleotide polymorphisms (SNPs) are investigated in GWASs to ascertain whether, on a SNP-by-SNP basis, particular SNPs are causal or tagging of causal with respect to the certain phenotype.

Attempting to ascertain whether a SNP is causal or tagging of causal with respect to the certain phenotypes is a computationally expensive task. For example, a human body has approximately 50 trillion cells, and each cell has approximately 20,000 genes therein. A gene is a small portion of the Deoxyribonucleic acid (DNA) of an individual, where DNA is a double-stranded molecule composed of sugars and phosphate groups, and includes bases adenine, thiamine, cytosine, and guanine Long molecules of DNA that include genes are organized into portions that are referred to as chromosomes. Humans have 46 chromosomes: two sets of 23, and an entire set of 23 chromosomes is referred to as a genome.

The human genome is composed of approximately six billion base pairs, and a variation at a single base pair is a SNP. During cell generation, when the genome is copied, a single base pair can be removed, added, or substituted. Single base pair substitutions create SNPs. There are at least 10,000,000 SNPs in the human genome, which account for genetic differences between individuals. A subset of such SNPs account for differences in appearance, differences in how diseases are developed in individuals, differences in how individuals respond to certain environmental factors, such as pharmaceutical drugs, etc.

Phenotypes may arise from genes of individuals alone, from interaction of genes of the individuals and their respective environments, or solely from their respective environments. As can be ascertained, due to the large number of SNPs, it is computationally expensive to ascertain which subset of the 10 million potential SNPs are associated with a particular phenotype. Further, even after identifying which potential SNPs are associated with the particular phenotype, further analysis must be undertaken to identify a subset of the potential SNPs that are causal with respect to the particular phenotype (rather than confounding).

### SUMMARY

The following is a brief summary of subject matter that is described in greater detail herein. This summary is not intended to be limiting as to the scope of the claims.

Described herein are various technologies pertaining to undertaking a genome-wide association study (GWAS). With more particularity, various computer-implemented techniques for identifying, in a computationally efficient manner, single-nucleotide polymorphisms (SNPs) that are causal or tagging of causal with respect to a specified phenotype are set forth herein.

In connection with identifying the aforementioned SNPs, data can be analyzed, wherein the data includes values corresponding to numerous samples (e.g., humans). In an exemplary embodiment, data corresponding to a particular sample can comprise an identifier that identifies the sample, values for respective genetic markers (e.g., SNPs) of the sample, and values for respective phenotypes, wherein a value for a phenotype can be indicative of whether or not the sample expresses the phenotype. Again, the data can include such information for numerous samples.

The data can be analyzed with respect to a specified phenotype to identify a set of genetic markers that are predictive of (e.g., associated with) the specified phenotype. Such genetic markers can be referred to as a feature selected set of markers. That is, if values for the feature selected set of markers are received with respect to a sample, such values can be employed to predict whether the sample expresses the phenotype. Pursuant to an example, the feature selected set of markers can be identified by univariately analyzing each genetic marker represented in the data and computing a respective association value for each genetic marker. The feature selected set of markers that are predictive of the specified phenotype can be identified based upon association values of genetic markers in such feature selected set of markers.

Subsequent to the feature selected set of markers being identified, a marker group can be identified as being causal or tagging of causal with respect to the phenotype (rather than confounding). Specifically, the feature selected set of markers may include both causal genetic markers (genetic markers that cause the phenotype), tagging genetic markers (genetic markers that are proximate to causal genetic markers), and confounding genetic markers (e.g., genetic markers that are influenced by, for instance, environment, and are therefore predictive of the phenotype but not causal or tagging of causal). Determining whether the marker group is causal or tagging of causal can be accomplished through, for example, analysis of the marker group conditioned upon the feature selected set of markers (potentially exclusive of any overlapping markers between the marker group and the feature selected set of markers). A linear mixed model (LMM) includes a similarity matrix, which is also referred to as a covariance matrix, or a kernel matrix. In an exemplary embodiment, the similarity matrix can be the combination of two (or more) matrices: a first matrix comprising values corresponding to the marker group desirably analyzed; and a second matrix comprising values corresponding to the feature selected set of markers. A LMM algorithm can be executed over such a similarity matrix, for example, to obtain a maximum likelihood estimate of parameters, which can be used to determine the likelihood of data given those parameters.

To ascertain whether the marker group is causal or tagging of causal with respect to the phenotype, the score test can be applied. The score test is a relatively accurate tool for eliminating candidate sets of causal or tagging of causal genetic markers. If the output of the score test indicates the marker group as likely being causal or tagging of causal, then a likelihood ratio test can be employed to ensure accuracy of the score test (which may not be accurate for alternative hypotheses with parameters far from those of the null model).

Other aspects will be appreciated upon reading and understanding the attached figures and description.

### BRIEF DESCRIPTION OF THE DRAWINGS

FIG. 1 is a functional block diagram of an exemplary system that facilitates computing values that are indicative of univariate predictive ability of a genetic marker with respect to a specified phenotype.

FIG. 2 illustrates an exemplary data structure that can retain data utilized in genome-wide association studies.

FIG. 3 is a functional block diagram of an exemplary system that facilitates identifying a feature selected set of markers with respect to a phenotype.

FIG. 4 is a functional block diagram of an exemplary system that facilitates identifying sets of genetic markers that are causal or tagging of causal with respect to a specified phenotype.

FIG. 5 is a flow diagram illustrating an exemplary methodology for univariately analyzing genetic markers as to their respective abilities to predict a specified phenotype.

FIG. 6 is a flow diagram that illustrates an exemplary methodology for outputting values that are indicative of whether a set of genetic markers are causal or tagging of causal with respect to a specified phenotype.

FIG. 7 is a flow diagram that illustrates an exemplary methodology for outputting an association value that is indicative of whether a genetic marker or set of genetic markers is causal or tagging of causal with respect to a specified phenotype.

FIG. 8 is an exemplary computing system.

### DETAILED DESCRIPTION

Various technologies pertaining to identifying genetic markers that are causal or tagging of causal with respect to a phenotype will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

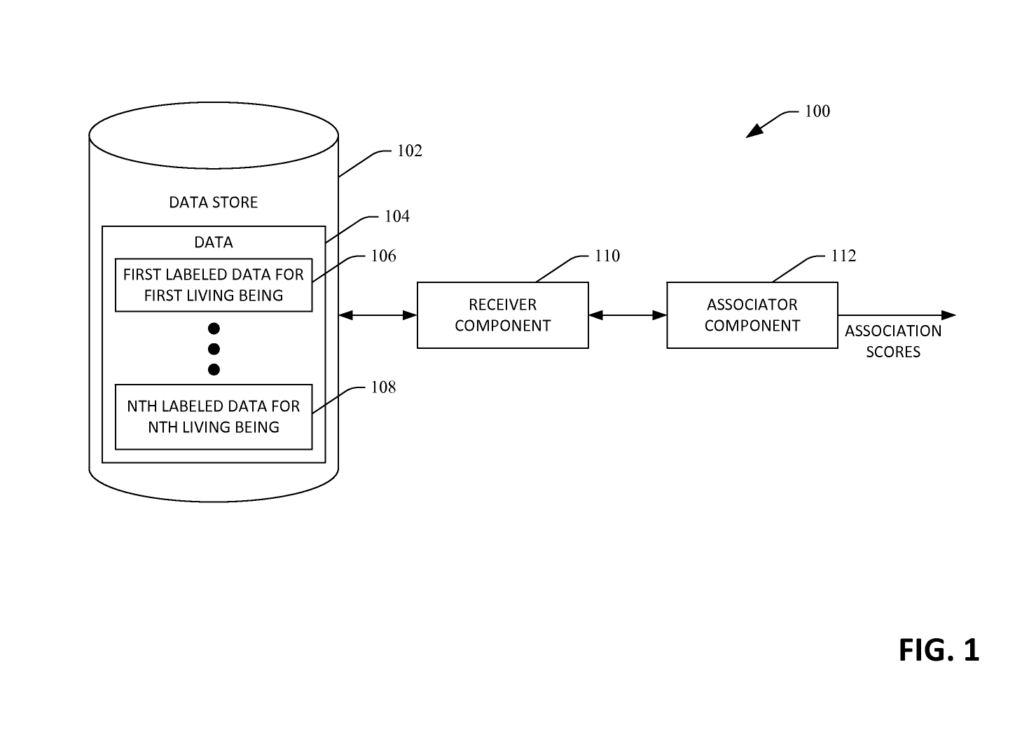

With reference now to FIG. 1, an exemplary system 100 that facilitates identifying genetic markers that are causal or tagging of causal with respect to a specified phenotype of a living being is illustrated. The specified phenotype can be discrete in nature (e.g. whether the living being is susceptible to a particular disease), continuous (height, weight, hair color, etc.), or real-valued (e.g. value of blood pressure measurements). The living being can be a human being, a domesticated animal (dog, cat, etc.), livestock (cow, goat, horse, etc.), exotic animal (lion, tiger, elephant, etc.), a plant (including a flower, a crop, etc.), an aquatic animal, a rodent, an insect, or any other suitable living being that includes genetic markers. The specified phenotype can be any suitable trait of a living being. Further, the specified phenotype can be a molecular phenotype.

It is further to be understood that higher order interactions among genetic markers can be contemplated when identifying causal or tagging of causal genetic markers. In an example, it can be learned that certain genetic markers (or non-genetic covariates), when considered in conjunction, are associated with a phenotype or set of phenotypes, but when considered separately, are not associated with the phenotype of set of phenotypes. When several genetic markers are combined into a single new feature, this feature is referred to as a “higher order feature”. A higher order feature can be specified a priori, such that genetic markers in certain features are always considered in conjunction. Additionally, while single-nucleotide polymorphisms (SNPs) are specified as being the genetic markers in examples set forth herein, it is to be understood that genetic markers are not limited to SNPs.

The system 100 can be directed towards identifying a set of SNPs that are collectively predictive for a certain phenotype, or toward identifying individual SNPs where each is predictive for a certain phenotype. This set of SNPs can be referred to herein as a feature selected set of markers. That is, for example, if values for SNPs in the features selected set of SNPs are known for an individual, a prediction with better certainty can be made as to whether the certain phenotype is expressed in the individual (relative to when such values for the SNPs are unknown). Such set of SNPs can include causal SNPs, tagging SNPs, and confounding SNPs.

The system 100 comprises a data store 102 that includes data 104. The data 104 includes first labeled data 106 for a first living being through Nth labeled data 108 for an Nth living being. The first labeled data 106 comprises values for respective markers for the first living being as well as values pertaining to phenotypes (e.g., whether the phenotype is expressed in the first living being, extent to which the phenotype is expressed in the first living being, . . . ). The term “marker”, as used herein, is intended to encompass both genetic markers, such as SNPs, higher order features, covariates such as race, gender, and age, and the like. Accordingly, optionally, the first labeled data 106 comprises values for respective non-genetic features for the first living being and/or values for respective higher order features for the first living being. Similarly, the Nth labeled data 108 comprises similar values for markers of the Nth living being as well as values pertaining to phenotypes.

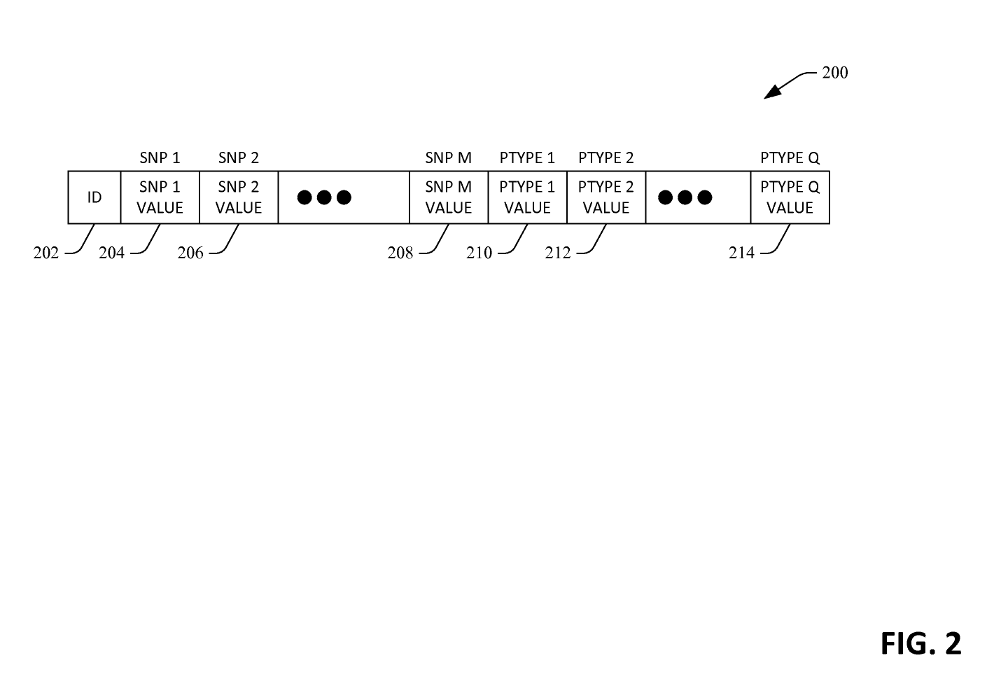

Turning briefly to FIG. 2, an exemplary data structure 200 for labeled data is illustrated. The data structure 200 is shown as being an array; it is to be understood, however, that other data structures are contemplated. The data structure 200 includes a field 202 that includes data that identifies the living being from amongst other living beings represented in the data 104. Such data can be anonymous in nature, such as a number that anonymously distinguishes the living being from other living beings represented in the data 104. The data structure further includes a first plurality of fields 204-208 that include respective values for M SNPs of the living being. In an example, such values can be binary in nature, although values in the fields 204-208 are not so limited. The data structure 200 further comprises a second plurality of fields 208-212 that include respective values for Q phenotypes. For a particular phenotype, a corresponding value in the data structure 200 can indicate whether such phenotype is expressed in the living being, can indicate an extent to which the phenotype is expressed in the living being, can indicate a value from amongst a plurality of potential values of the phenotype (e.g., hair color as being blonde, brunette, black, . . . ), etc.

Returning to FIG. 1, a receiver component 110 can receive the data from the data store 102. An associator component 112 is in communication with the receiver component 110, and can output a list of markers for a specified phenotype. In an exemplary embodiment, the list of markers includes only SNPs. More specifically, the associator component 112 computes respective association scores for markers represented in the data 104, wherein an association score assigned to a marker is indicative of its ability to predict the specified phenotype using solely such marker. Such ability to predict can be measured in-sample or out-of-sample (e.g., with cross validation). An exemplary score can be the log likelihood of the data.

In an exemplary embodiment, using cross-validation, the associator component 112 computes association scores for respective markers represented in a training fold (a portion of the data 104) to create an order of markers, wherein a score assigned to a marker is indicative of an ability to predict the phenotype using solely such marker. Subsequently, as described below, increasing numbers of markers according to the order are used to predict out-of-sample for such training fold. The process can be repeated for each fold, using increasing numbers of markers, until an optimal out-of-sample prediction is obtained.

Continuing with the above, the associator component 112 can comprise a linear regression algorithm that performs a univariate linear regression procedure over a marker to assign an association score to the marker based upon its ability to predict the specified phenotype. The associator component 112, in an example, can perform such univariate linear analysis over each marker represented in the data 104. If the associator component 112 assigns a relatively high association score to a marker with respect to the specified phenotype, then it can be inferred that the marker is likely either to be indirectly associated with the phenotype (e.g., by way of population structure) or to have an effect on the phenotype (directly or by tagging). The associator component 112 may then order the markers by their respective linear regression values, and can output a ranked list of markers for the specified phenotype.

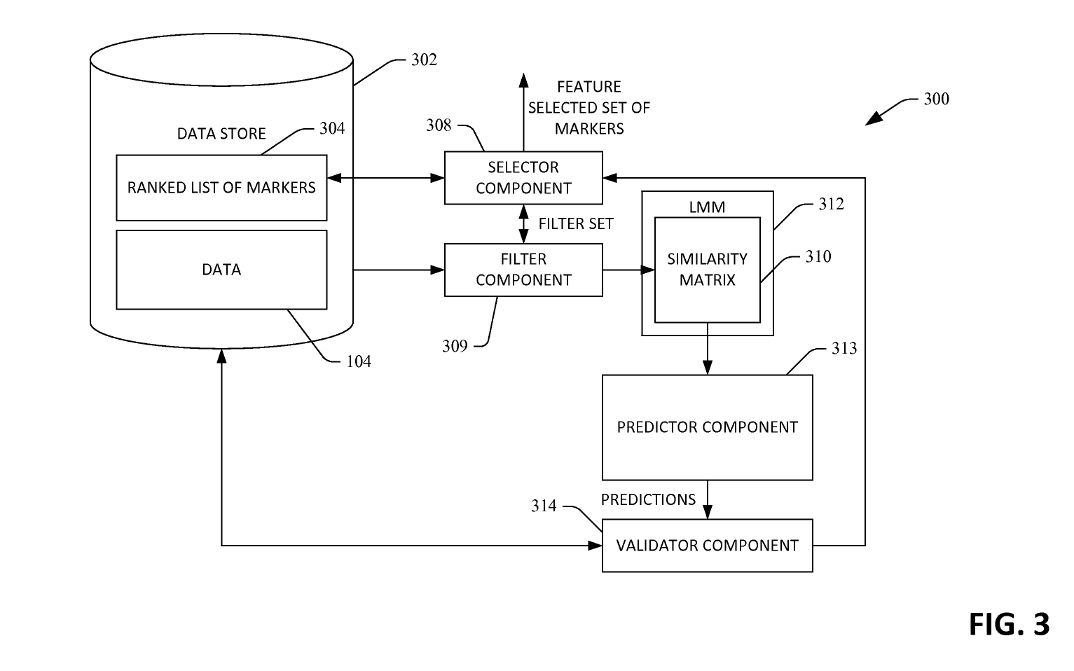

Turning now to FIG. 3, an exemplary system 300 that facilitates identifying a feature selected set of markers is illustrated, wherein the feature selected set of markers comprises markers that are collectively identified as being highly predictive of the specified phenotype. The system comprises a data store 302 that includes a ranked list of markers 304 as output, for example, by the associator component 112. The data store 302 further comprises the data 104.

The system 300 comprises a selector component 308 that selects, from the ranked list of markers 304, a filter set, wherein the filter set includes some number of most highly ranked markers in the ranked list of markers 304. The system 300 further comprises a filter component 309, which receives the filter set from the selector component 308 and extracts values for markers in the filter set from the data 104. The filter component 309 then yields a similarity matrix 310 of a linear mixed model 312 based upon the extracted values. A predictor component 313 executes a predictive algorithm over the linear mixed model 312 to output a prediction as to whether the specified phenotype is expressed in a test living being from the data 104. The predictor component 313 can output predictions for several test living beings in the data 104, and a validator component 314 can validate predictions output by the predictor component 313, for instance, through cross-validation. Accordingly, the validator component 314, for the filter set selected by the selector component 308, can output a value that is indicative of the predictive accuracy of the predictor component 313 for the specified phenotype when the similarity matrix 310 is based upon values for genetic markers in the filter set.

Subsequent to the validator component 314 outputting a value that is indicative of predictive accuracy of the predictor component 313 when the similarity matrix is derived from values for genetic markers in the filter set, the selector component 308 can expand the filter set as described above (regardless of the initial value output by the validator component 314). The filter component 309 can yield a similarity matrix with values arising from genetic markers in the updated filter set, and the predictor component 313 can output predictions as to whether test living beings have the phenotype or set of phenotypes based at least in part upon the similarity matrix. The validator component 314 can thereafter, through cross-validation, compute a value that is indicative of predictive accuracy of the predictor component 313 when the similarity matrix 310 includes values based upon genetic markers in the updated filter set. The selector component 308 can receive this value and compare the value with previous values output by the validator component 314 with respect to previously employed filter sets. If there is an improvement, then the filter set can be further expanded, and the process iterates until the predictive accuracy is optimized. In experimentation, it has been found that, at least for some phenotypes, considering more markers when predicting phenotypes causes predictive accuracy to decline when compared to when fewer markers are considered when predicting for such phenotypes. Therefore, the selector component 308 can select the filter set that causes the predictive accuracy of the predictor component 313 to be optimized when predicting for the specified phenotype. As noted above, such an optimized set can be referred to herein as a feature selected set of markers.

With respect to the predictor component 313, an algorithm that can be employed thereby to perform prediction can be a linear mixed model (LMM) algorithm. An exemplary LMM algorithm is explained in connection with performing a GWAS in Lippert, et al, “Fast Linear Mixed Models for Genome-Wide Association Studies”, Nat. Methods, Sep. 4, 2011, Pages 1-5, the entirety of which is incorporated herein by reference. Adaption of the algorithm for utilization when predicting a phenotype will be readily contemplated by one skilled in the art.

The exemplary technique set forth above for identifying the feature selected set of markers is not the sole technique that is employable for identifying such feature selected set of markers. In an exemplary embodiment, quality of the LMM 312 is measured in-sample, and the selector component 308 selects markers that correspond to when the first minimum is obtained in the genomic control factor. In another exemplary embodiment, quality of the LMM 312 is measured in-sample, and the selector component 308 selects markers that correspond to when the second lowest minimum in the genomic control factor is obtained.

In still yet another exemplary embodiment, quality of the LMM 312 is measured with cross-validation, L1 feature selection with a varying penalty term is applied to the top K markers, and the criterion for selecting the best penalty term is out-of-sample log likelihood. Subsequent to the best penalty term being identified, the selector component 308 can use such term in conjunction with L1 feature selection on the data 104 to select the feature selected set of markers.

In another exemplary embodiment, quality of the LMM 312 can be measured with cross-validation, and the selector component 308 can utilize forward-backward selection to search for the markers to include in the feature selected set of markers. The selector component 308 can cease searching when a decrease in the cross-validated log-likelihood is observed.

In yet another exemplary embodiment, quality of the LMM 312 can be measured with cross-validation, and the selector component 308 can use forward selection followed by backward selection to search for markers to include in the feature selected set of markers. The selector component 308 can cease each search when identifying a decrease in the cross-validated log likelihood.

In still yet another exemplary embodiment, the quality of the LMM 312 can be measured with in-sample marginal likelihood, wherein the selector component 308 performs an optimization over a Bayesian model using a method for “automatic relevance determination” on all markers, for example, by placing an appropriate inverse-Gamma prior distribution on the variance of each marker-weight (in the equivalent Bayesian linear regression model) and the variance of the environmental noise. Automatic relevance determination is a method to perform feature selection in Bayesian statistical models described in MacKay, “Bayesian Interpolation”, Neural Computation, Vol. 4, Pages 415-447, 1992. The result of performing, for example, maximum a posteriori estimation of individual variances is a relatively small set of markers that have a variance that deviates from zero and an estimate of the noise variance. This is described in Tipping, “Sparse Bayesian Learning and the Relevance Vector Machine”, Journal of Machine Learning Research 1, Pages 211-244, 2001. Each marker that remains after selection can be multiplied by the square-root of the variance estimate. The similarity matrix 310 is embodied with the resulting set of re-weighted markers. The resulting similarity matrix is likely to explain the phenotype too well (over-fitting). To avoid such over-fitting, and P-values that are too large (deflation), the lower bound of the parameter delta in the linear mixed model can be set to the estimate of the variance inferred for the noise.

In another exemplary embodiment, techniques described above can be used for case-control phenotypes, except that the quality of the LMM 312 is measured with in-sample marginal likelihood, optimizing over a Bayesian model that adds a Bernoulli likelihood distribution on the case-control status of each living being represented in the data 104. In this case, the continuous outcome of the linear mixed model is mapped to values between zero and one by means of a sigmoid or logit link function, such as noted in Eq. (23) of Tipping, noted above. A method for “automatic relevance determination” can be undertaken on all markers, for example, by placing an appropriate inverse-Gamma prior distribution on the variance of each feature-weight (in the equivalent Bayesian logistic regression model) and the variance of the environmental noise. As noted above, the result of performing, for example, maximum a posteriori estimation of the individual variances will be a relatively small set of markers that have a variance that deviates from zero and an estimate of the noise variance. Each marker that remains after selection is multiplied by the square-root of the variance estimate. The similarity matrix 310 is embodied with the resulting set of re-weighted markers.

In yet another exemplary embodiment, the techniques described above for identifying the feature selected set of markers can be employed, except that the quality of the LMM 312 is measured with in-sample marginal likelihood, optimizing over a Bayesian model using a method for “automatic relevance determination” (as described above) on a set of markers, which is pre-filtered by performing a linear regression scan and retaining the set of most significant markers of appropriate size, typically between 5000 and 20000. This technique can be used to obtain a computational speedup relative to other techniques noted above.

The above has set forth numerous techniques for identifying the feature selected set of markers represented in the data 104. It is to be understood that techniques pertaining to identifying causal markers and/or tagging markers, as described below, can be employed with any of such techniques or other techniques not noted herein.

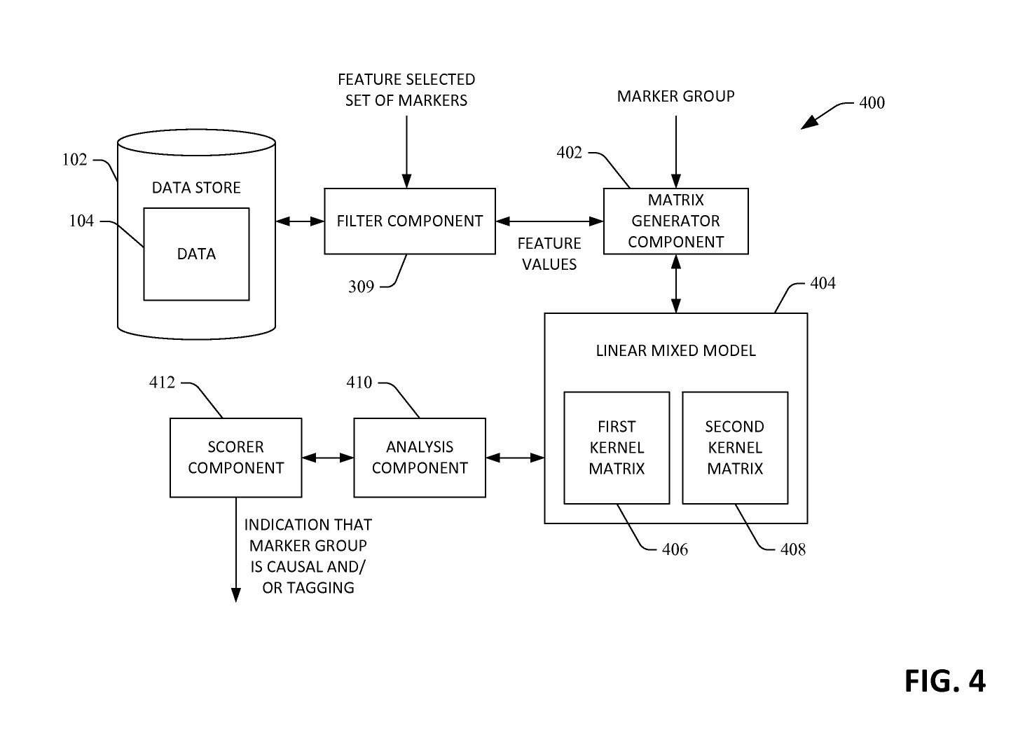

Now referring to FIG. 4, an exemplary system 400 that facilitates identifying sets of genetic markers that are causal or tagging of causal as to the specified phenotype (rather than confounding) is illustrated. It is to be understood that the system 400 can be employed to simultaneously analyze multiple genetic markers as to whether such multiple genetic markers are causal or tagging as to the specified phenotype. Traditional Genome Wide Association Studies (GWAS) test one marker (e.g., SNP) at a time for association with a phenotype, such as disease, thereby overlooking interplay between SNPs within a gene or pathway, missing weak signals that aggregate in groups of related SNPs, and incurring a severe penalty for multiple testing. Conventional methods for analyzing SNPs as to whether they are causal or tagging as to the specified phenotype are unable to handle a confounding structure such as occurs, for instance, when related individuals of diverse ethnic backgrounds are included in a study, resulting in loss of power and spurious associations. Such richly structured cohorts, however, yield the most power for discovery of the genetic underpinnings of complex traits. In addition, such structure typically presents itself as data cohorts become larger and larger to enable the discovery of a weak signal. The system 400 facilitates group testing of SNPs utilizing a relatively computationally efficient approach that accounts for rich confounding structure.

The system 400 includes the data store 102, which comprises the data 104. The filter component 309 accesses the data 104, and extracts values for the feature selected set of markers for the specified phenotype identified by the selector component 308. Such extracted values can be referred to as feature values. Thus, the feature values include values for markers found to be predictive (the feature selected set of markers) through utilization of the system 300.

The system 400 also comprises a matrix generator component 402 that receives the feature selected set of values and generates two kernel matrices (similarity matrices) of a LMM 404 with two sets of values: a first set of values derived from a pre-defined marker group; and a second set of values derived from the feature selected set of markers (potentially excluding markers from the marker group). The pre-defined marker group includes, for instance, SNPs that are desirably subject of analysis, and can include markers from the feature selected set of markers, but can also include other SNPs. Thus, the LMM 404 can comprise a first kernel matrix 406 and a second kernel matrix 408, wherein the first kernel matrix 406 is derived from the first set of values and the second kernel matrix 408 is derived from the second set of values.

An analysis component 410 accesses the LMM 404 and executes an LMM algorithm thereover. For instance, such LMM algorithm can be any suitable algorithm to fit the LMM 404, including an expectation-maximization algorithm. A scorer component 412 receives output of the analysis component 410, and determines whether the marker group (which can include a single marker or numerous markers) is causal or tagging as to the specified phenotype (e.g., conditioned on, for example by way of the kernel, the feature selected set of markers).

With more detail pertaining to the LMM 404, such LMM 404 is employed to perform group tests (e.g., such as testing the marker group) in the presence of confounding within a single, robust, and well-defined statistical model. A group test, which utilizes the kernel to test a set of SNPs in such a model, is formally well-defined and yields accurate P values in closed-form (e.g., does not require permutations to obtain P values). Furthermore, because such a test employed in connection with the LMM 404 has a single degree of freedom despite testing many SNPs jointly, such test is relatively powerful. Moreover, the LMM 404 has a direct interpretation as penalized multivariate regression, but allows an empirical Bayes approach to set the parameters of the LMM 404, thereby obviating the need to do cross-validation for finding the penalty.

An exemplary approach that can be employed through utilization of the system 400 relies on Bayesian linear regression (equivalent to the LMM) with two distinct sets of covariates (equivalently two kernels in the LMM), which have been briefly mentioned above. The first set of covariates includes genetic markers that correct for confounding: that is, those which predict race and relatedness, for example. Their inclusion can make the data for living beings independently and identically distributed (e.g., knowing the value of these genetic markers induces a common distribution from which the living beings are drawn). The second set of covariates consists of the marker group—a set of genetic markers of interest, for which it is desirable to test association—such as SNPs belonging to a gene, or a pathway, or those close together on the chromosome. The regression weight for each marker covariate in a given set is assigned a prior distribution, which is Gaussian with zero mean; the variance of this distribution is the same for every marker within the given set, but is generally different between the two sets, and is typically learned from the data 104. For example, the two variances can be estimated using maximum likelihood, restricted maximum likelihood, or other suitable technique. Equivalently, the approach described with respect to FIG. 4 can be viewed as a LMM with two random effects: a first random effect that captures confounding in a manner similar to the common usage of a LMM for correcting of confounding in GWAS; and a second random effect that captures the signal for the test set. By including the first random effect, which captures a rich covariance structure among the living beings, the living beings effectively become decorrelated, thereby avoiding spurious signal and loss of power otherwise caused by such structure.

As noted above, given the structure of the LMM 404 described herein, the analysis component 410 can output maximum likelihood of data with the marker group and maximum likelihood of data without the marker group. The scorer component 412 can compare the maximum likelihood of the data with and without the second set of covariates representing the test set of genetic markers (e.g., the SNPs within a gene); that is, the likelihood of the alternative and null models. In an exemplary embodiment, the scorer component 412 can undertake such comparison in closed-form using a likelihood ratio test (LRT). It can be noted that to compute the likelihood for such a model, that is the LMM 404 with two random effects, is naively relatively expensive, as it scales cubically with the number of living beings represented in the data 104. Accordingly, the analysis component 410 can be configured to execute a two-random effects algorithm, which is linear in the number of living beings represented in the data 104.

The LRT for the LMM 404 model can be made faster than the naive implementation in three ways, for example. The first is to view the two kernel matrices 406 and 408 of the LMM 404 as a single kernel matrix, composed of two sub-matrices added together with an unknown mixing weight. Equivalently, one can view such single kernel matrix as resulting from an inner product from a matrix concatenation of two sets of genetic markers, with an unknown mixing weight. Such approach is described in Listgarten, et al., “An Efficient Group Test for Genetic Markers that Handles Confounding”, arXiv: 1205.0793, 2012, Pages 1-13, the entirety of which is incorporated herein by reference. In this view, the analysis component 410 can employ a one-dimensional optimization (such as Brent search) over the unknown mixing weight, in combination with techniques described in Lippert, et al, “Fast Linear Mixed Models for Genome-Wide Association Studies”, Nat. Methods, Sep. 4, 2011, Pages 1-5. It can be readily appreciated that techniques disclosed therein to avoid proximal contamination may be adapted and employed.

A second approach is that the analysis component 410 can use the matrix determinant and inversion lemmas in order to avoid re-computing the inversion and determinant of the variance component comprising two kernels with a mixing weight.

A third approach that can be undertaken by the analysis component 410 is to utilize the scorer component 412 to employ the score test, which avoids having to compute the parameters under the alternative model. However, the score test itself, naively implemented, scales cubically in the number of living beings in the data 104, whereas, using identities derived in Listgarten, et al., “Improved Linear Mixed Models for Genome-Wide Association Studies”, Nature Methods, Vol. 9, Pages 535-526, June 2012, and generalizations thereof, the score test can be re-written in a low-rank form, making its computation linear in time and space in the number of living beings. The entirety of the aforementioned reference is incorporated herein in its entirety.

Furthermore, because the score test can be viewed as an approximation to the LRT, it is, naively, sub-optimal to use as compared to the LRT itself. Thus, the scorer component 412 can be employed to develop a hybrid approach which employs the score test as a fast screening procedure to rule out certain tests (in general, a large number) from being considered from the LRT, and only executing the LRT itself on the remaining hypotheses of interest. Because the score test is much faster than the LRT test, this provides significant savings in computation time relative to the low rank versions of the LRT described above. In particular, the fast screening score test procedure employed by the scorer component 412 involves running the score test on all hypotheses, and then, for any hypotheses which fall into any one of the following categories, for example, re-computing its p-value using the LRT test: (1) if any of the eigenvalues of the Hessian (observed information) of the log likelihood, or of the efficient observed information, are non-negative, (2) if the condition number of the observed (efficient) information is too large, or (3) if the p-value resulting from the score test is small enough that the test will be reported as significant, by whatever criterion are being used to call significance.

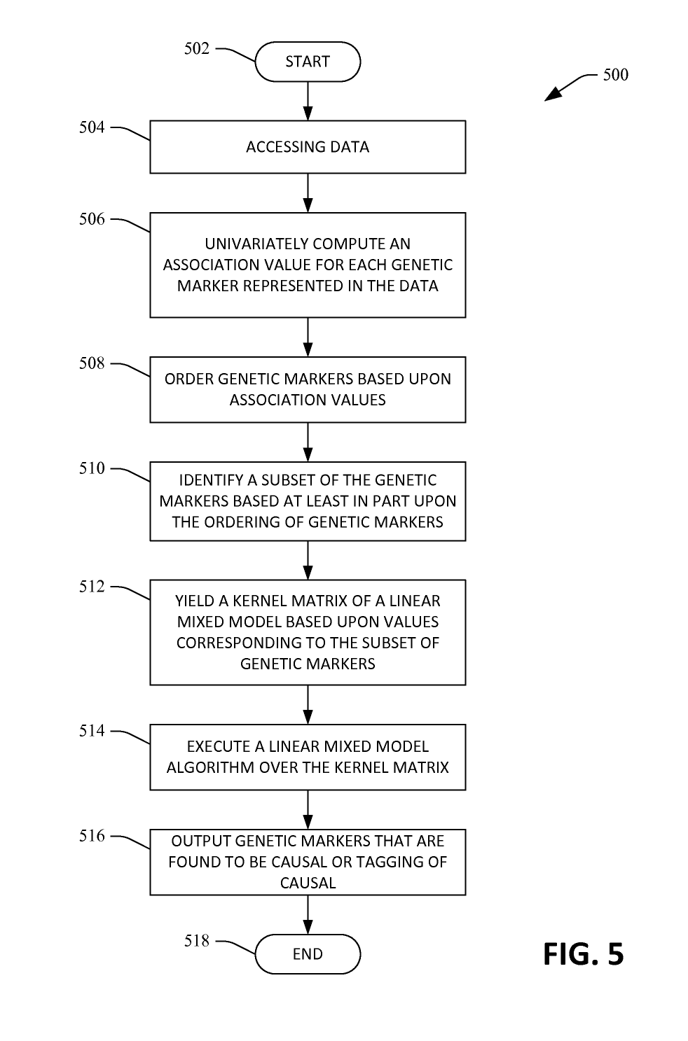

With reference now to FIGS. 5-7, exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Referring solely to FIG. 5, an exemplary methodology 500 that facilitates identifying genetic markers that are causal or tagging with respect to a specified phenotype is illustrated. The methodology 500 starts at 502, and at 504 data is accessed, wherein the data comprises, for each living being in a plurality of living beings represented in the data, labels for potential phenotypes of a respective living being and values for respective genetic markers (e.g., SNPs) of the respective living being.

At 506, for the specified phenotype, association values are computed for respective genetic markers in the genetic markers represented in the data. An association value for a respective genetic marker can be indicative of an ability to predict that a living being has the specified phenotype based solely upon the respective genetic marker, and wherein the association value is computed based at least in part upon the data.

At 508, genetic markers are ordered based upon respective association values computed for the genetic markers, and at 510, a subset of the genetic markers is identified based at least in part upon the ordering of the genetic markers. Such a subset has been referred to herein as the feature selected set of markers.

At 512, a kernel matrix is yielded based upon values corresponding to the subset of genetic markers identified at 510. At 514, a LMM algorithm is executed over the kernel matrix, and at 516 genetic markers from the subset of genetic markers identified at 510 are determined to be causal or tagging as to the specified phenotype based at least in part upon the executing of the LMM algorithm over the kernel matrix. The methodology 500 completes at 518.

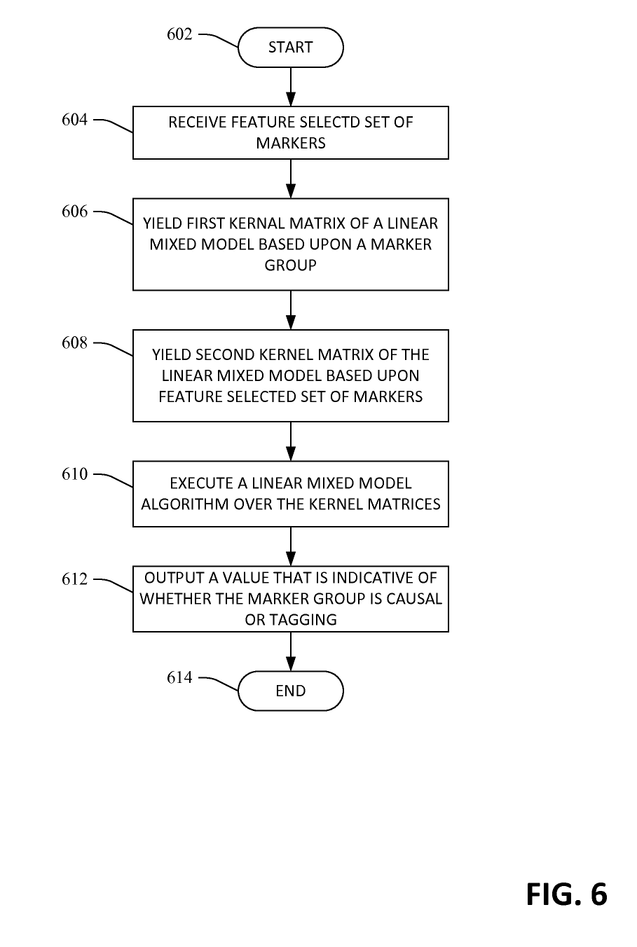

With reference now to FIG. 6, an exemplary methodology 600 that facilitates outputting a value that is indicative of whether a test set of genetic markers is causal or tagging with respect to a specified phenotype is illustrated. The methodology 600 starts at 602, and at 604, a set of predictive markers (features selected set of markers) is received, wherein the predictive markers have been identified in a training phase as being predictive of a specified phenotype.

At 606, a first kernel matrix of an LMM is yielded based upon values resulting from the feature selection on a marker group, the marker group comprising at least two genetic markers. At 608, a second kernel matrix of the LMM is yielded based upon values corresponding to a set of genetic markers that are associated with confounding with respect to the specified phenotype. At 610, a LMM algorithm is executed over the first kernel matrix and the second kernel matrix, and at 612 a value is output that is indicative of whether the test set of genetic markers is causal and/or tagging with respect to the specified phenotype based at least in part upon the executing of the LMM algorithm over the first kernel matrix and the second kernel matrix. The methodology 600 completes at 614.

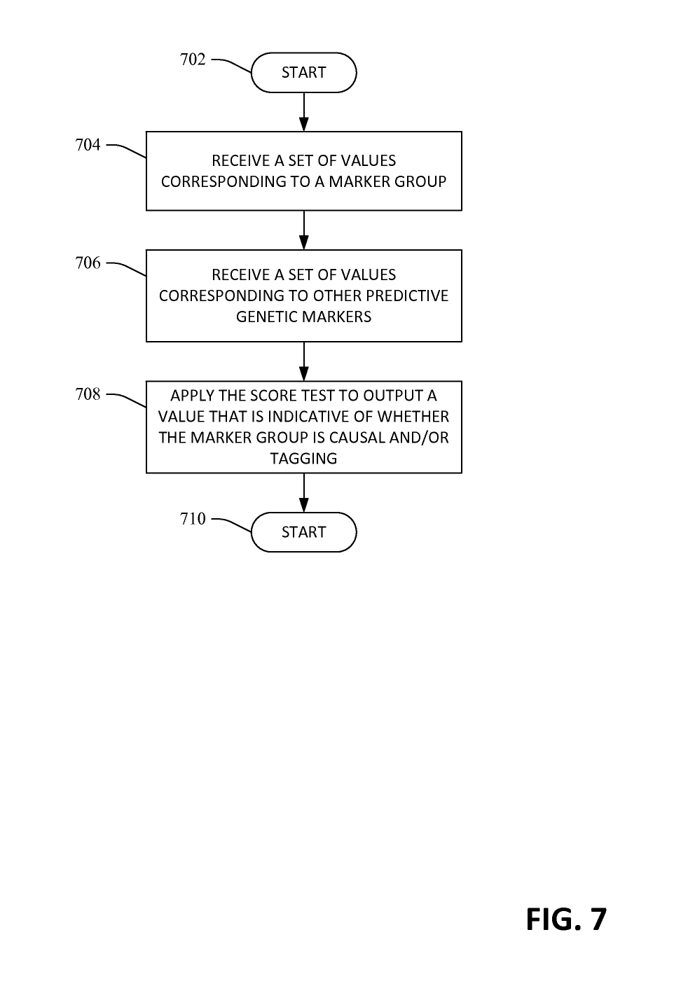

Now referring to FIG. 7, an exemplary methodology 700 that facilitates identifying genetic markers in a genome that are causal or tagging with respect to a specified phenotype is illustrated. The methodology 700 starts at 702, and at 704, a set of values corresponding to a marker group is received, the marker group comprising at least two genetic markers. At 706, a set of values corresponding to a set of genetic markers that are associated with the specified phenotype are received (the feature-selected set of markers). At 708, the score test is applied to output a value that is indicative of whether the marker group is causal or tagging with respect to the specified phenotype. The value is computed based at least in part upon the set of values corresponding to the marker group and the set of values corresponding to the set of genetic markers that are associated with the specified phenotype. The methodology 700 completes at 710.

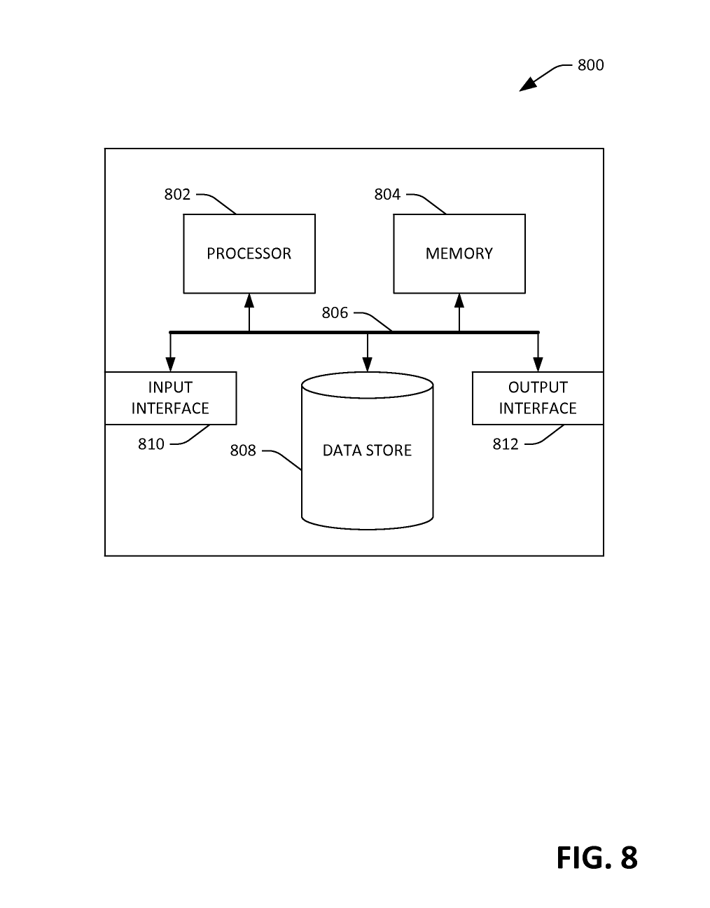

Now referring to FIG. 8, a high-level illustration of an exemplary computing device 800 that can be used in accordance with the systems and methodologies disclosed herein is illustrated. For instance, the computing device 800 may be used in a system that supports computing association values for genetic markers that are indicative of predictive abilities of such genetic markers with respect to a specified phenotype. In another example, at least a portion of the computing device 800 may be used in a system that supports identifying genetic markers that are causal or tagging with respect to the specified phenotype. The computing device 800 includes at least one processor 802 that executes instructions that are stored in a memory 804. The memory 804 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store values for genetic markers, data indicating whether samples express certain phenotypes, etc.

The computing device 800 additionally includes a data store 808 that is accessible by the processor 802 by way of the system bus 806. The data store may be or include any suitable computer-readable storage, including a hard disk, memory, etc. The data store 808 may include executable instructions, values for genetic markers for samples, values for phenotypes of samples, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that facilitates determining whether a marker group is causal or tagging of causal with respect to a specified phenotype, the method executed by a processor of a computing device, the method comprising:
accessing data, the data comprising, for each living being in a plurality of living beings represented in the data:
phenotypes of a respective living being; and
values for respective markers for the respective living being;
for the specified phenotype, univariately computing an association score for each respective marker in the markers, the association score being indicative of an ability to predict that a living being has the specified phenotype based solely upon the respective marker, wherein the association score is computed based at least in part upon the data;
ordering markers based upon respective association scores computed for the markers;
identifying a feature selected set of markers based at least in part upon the ordering of the markers;
generating a kernel matrix of a linear mixed model based at least in part upon values corresponding to the feature selected set of markers;
executing a linear mixed model algorithm over the kernel matrix of the linear mixed model to generate an output; and
outputting an indication that a marker group is causal or tagging of causal as to the specified phenotype based at least in part upon the output.

2. The method of claim 1, wherein the plurality of living beings are human beings.

3. The method of claim 2, wherein the markers comprise at least one of single nucleotide polymorphisms or higher order derivatives thereof.

4. The method of claim 1, further comprising executing the score test based at least in part upon the output to generate the indication that the marker group is causal or tagging of causal with respect to the specified phenotype, wherein processor cycles employed to execute the score test based at least in part upon the output scales linearly with a number of living beings in the plurality of living beings.

5. The method of claim 1, wherein generating the kernel matrix of the linear mixed model comprises:
generating a first kernel matrix of the linear mixed model based at least in part upon values corresponding to genetic markers in the marker group, the marker group comprising at least one genetic marker;
generating a second kernel matrix of the linear mixed model based at least in part upon the values corresponding to the feature selected set of markers; and
combining the first kernel matrix with the second kernel matrix to create the kernel matrix of the linear mixed model.

6. The method of 1, wherein computing the association value for each respective marker in the feature selected set of markers comprises executing a linear regression algorithm over the data.

7. The method of claim 5, wherein identifying the feature selected set of markers based at least in part upon the ordering of the markers comprises measuring an ability of the feature selected set of markers to predict the specified phenotype.

8. The method of claim 7, wherein the measuring of the ability of the feature selected set of markers to predict the specified phenotype is undertaken in-sample.

9. The method of claim 7, wherein the measuring of the ability of the feature selected set of markers to predict the specified phenotype is undertaken out-of-sample.

10. The method of claim 1, wherein identifying the feature selected set of markers based at least in part upon the ordering of the markers comprises selecting the feature selected set of markers based at least in part upon a value of a genomic control factor.

11. The method of claim 1, wherein the output comprises a P value with respect to the linear mixed model, wherein the kernel matrix comprises a weighted combination of a first kernel matrix and a second kernel matrix, the first kernel matrix derived from the marker group, the second kernel matrix derived from the feature selected set of markers.

12. A system, comprising:
a matrix generator component that generates:
a first kernel matrix of a linear mixed model with values derived from a marker group, the marker group comprising at least one genetic marker; and
a second kernel matrix of the linear mixed model with values derived from a feature selected set of genetic markers, the feature selected set of genetic markers identified as being predictive as to the specified phenotype; and
an analysis component that executes a linear mixed model algorithm over the linear mixed model to generate at least one output value, the at least one output value being indicative of whether the marker group is causal or tagging of causal with respect to the specified phenotype.

13. The system of claim 12, wherein the marker group comprises at least one of single nucleotide polymorphisms of respective human beings or higher order features of the respective human beings' markers.

14. The system of claim 12, wherein the matrix generator component combines the first kernel matrix and the second kernel matrix to generate a combined kernel matrix, and wherein the analysis component executes the linear mixed model algorithm over the combined kernel matrix.

15. The system of claim 12, further comprising an associator component that computes association scores for each genetic marker in a plurality of genetic markers based at least in part upon data that comprises respective values for the genetic markers for a plurality of living beings.

16. The system of claim 15, further comprising a selector component that selects the feature selected set of markers from the plurality of genetic markers based at least in part upon the association scores computed by the associator component.

17. The system of claim 12, wherein the analyzer component executes a likelihood ratio test over the linear mixed model in computing time that is linear with a number of samples in data considered by the generator component when generating the first kernel matrix and the second kernel matrix.

18. The system of claim 12, further comprising a scorer component that executes the score test based at least in part upon the at least one output value, wherein the scorer component outputs an indication as to whether the marker group is causal or tagging of causal with respect to the phenotype.

19. The system of claim 18, wherein the scorer component executes a likelihood ratio test based at least in part upon the at least one output value if either the Hessian contains a non-negative value or a statistical significance above a predefined threshold is identified.

20. A computer-readable medium comprising instructions that, when executed by a processor, cause the processor to perform acts pertaining to identifying genetic markers in a genome that are causal or tagging of causal with respect to a specified phenotype, the acts comprising:
receiving a set of values corresponding to a marker group, the marker group comprising at least one genetic marker;
receiving a set of values corresponding to a set of genetic markers that have been found to be predictive of the specified phenotype; and
applying the score test to output a value that is indicative of whether the marker group is causal or tagging of causal with respect to the specified phenotype, the value computed based at least in part upon the set of values corresponding to the marker group and the set of values corresponding to the set of genetic markers that are found to be predictive of the specified phenotype, and wherein the score test is executed, in computing time, linear in relation to a number of living beings employed in connection with identifying the set of genetic markers that have been found to be predictive of the specified phenotype.
